(19) United States
(12) Patent Application Publication
(10) Pub. No.: US 2013/0230745 A1
(43) Pub. Date: Sep. 5, 2013

(54) CURRENT INTERRUPTING DEVICE AND SECONDARY BATTERY USING THE SAME

(71) Applicants: Jun-Sun Yong, Yongin-si (KR); Chang-Seob Kim, Yongin-si (KR); Sang-Jin Lee, Yongin-si (KR); Moon-Hong Han, Yongin-si (KR)

(72) Inventors: Jun-Sun Yong, Yongin-si (KR); Chang-Seob Kim, Yongin-si (KR); Sang-Jin Lee, Yongin-si (KR); Moon-Hong Han, Yongin-si (KR)

(73) Assignee: SAMSUNG SDI CO., LTD.,, Yongin-si (KR)

(21) Appl. No.: 13/553,141

(22) Filed: Jul. 19, 2012

(30) Foreign Application Priority Data
Mar. 5, 2012 (KR) 10-2012-0022410

(51) Int. Cl. H01H 85/00; H01M 2/02; H01M 2/30; H01M 2/00

(52) U.S. Cl. 429/7; 337/142

(57) ABSTRACT

A current interrupting device and a secondary battery including the same. The current interrupting device includes a thermal fuse; a pair of conductive plates that are respectively connected to two opposite ends of the thermal fuse; and a sealing member which surrounds and seals the thermal fuse, wherein each of the conductive plates includes a connecting unit which is connected to the thermal fuse, and wherein at least one of the pair of conductive plates includes a deformation inducing unit which is arranged close to the connecting unit and has a smaller cross-sectional area than a cross-sectional area of the connecting unit.

### CLAIM OF PRIORITY

This application claims the benefit of Korean Patent Application No. 10-2012-0022410, filed on Mar. 5, 2012 in the Korean Intellectual Property Office, the disclosures of which are incorporated herein in their entirety by reference.

### BACKGROUND OF THE INVENTION

1. Field of the Invention

One or more embodiments of the present invention relate to a current interrupting device and a secondary battery using the same, the current interrupting device being designed to withstand external impact.

2. Description of the Related Art

Along with technical developments and increased production of mobile devices, such as mobile phones and laptop computers, demand for secondary batteries as power sources is rapidly increasing. For safety, such secondary batteries may include safety devices for detecting malfunctions thereof, such as overheating and overcurrent, and taking appropriate action for protecting the secondary battery, such as current interruption.

### SUMMARY OF THE INVENTION

One or more embodiments of the present invention include a current interrupting device that is resilient to an external force and a secondary battery including the same.

Additional aspects will be set forth in part in the description which follows and, in part, will be apparent from the description, or may be learned by practice of the presented embodiments.

According to one or more embodiments of the present invention, there is provided a current interrupting device that includes a thermal fuse, a pair of conductive plates respectively connected to two opposite ends of the thermal fuse and a sealing member that surrounds and seals the thermal fuse, wherein each of the conductive plates comprises a connecting unit that is connected to the thermal fuse, and wherein at least one of the pair of conductive plates comprises a deformation inducing unit that is arranged adjacent to the connecting unit and has a smaller cross-sectional area than a cross-sectional area of the connecting unit. The cross-sectional area of the deformation inducing unit may be from about 30% to about 50% of the cross-sectional area of the connecting unit. The deformation inducing unit may include a notch arranged in a widthwise direction of the current interrupting device. The deformation inducing unit comprises a notch arranged in a thickness-wise direction of the current interrupting device. A thickness of the connecting unit and a thickness of the deformation inducing unit may be smaller than a thickness of a body unit arranged opposite from the connecting unit of the conductive plate. The connecting units may be surrounded and sealed by the sealing member, and each of the at least one deformation inducing unit may be external and adjacent to the sealing member.

According to another aspect of the present invention, there is provided a secondary battery that includes an electrode assembly including a positive electrode plate, a separator, and a negative electrode plate, a can including an opening and a space to accommodate both the electrode assembly and an electrolyte, a cap plate to seal the opening of the can and a current interrupting device arranged inside the can, wherein the current interrupting device includes a thermal fuse, a pair of conductive plates that are respectively connected to two opposite ends of the thermal fuse and a sealing member that surrounds and seals the thermal fuse and the connections between the conductive plates and the thermal fuse, each of the conductive plates includes a connecting unit that is connected to the thermal fuse and a deformation inducing unit arranged adjacent to the connecting unit, wherein a cross-sectional area of the deformation inducing unit is smaller than a cross-sectional area of the connecting unit.

The cross-sectional area of the deformation inducing unit may be from about 30% to about 50% of the cross-sectional area of the connecting unit. The cross-sectional area of the connecting unit and the cross-sectional area of the deformation inducing unit may be smaller than a cross-sectional area of a body unit arranged opposite from the connecting unit of the conductive plate. The deformation inducing unit may include a notch arranged in a widthwise direction of the current interrupting device. The deformation inducing unit may also or instead include a notch arranged in a thickness-wise direction of the current interrupting device. A width of the deformation inducing unit may be smaller than a width of the connecting unit. A thickness of the deformation inducing unit may be smaller than a thickness of the connecting unit. The secondary battery may also include an electrode terminal including a first end exposed to an outside via a top surface of the cap plate and a second end penetrating through the cap plate and being combined with the current interrupting device and an electrode tab extending from the electrode assembly to the current interrupting device. The pair of conductive plates may include a first conductive plate perforated by an aperture, the electrode terminal extending through the aperture, and a second conductive plate including a groove that combines with a bottom surface of the cap plate. A thickness of the connecting unit and a thickness of the deformation inducing unit may be smaller than the thickness of a body unit arranged opposite from the connecting unit of the conductive plate. A width of the connecting unit and a width of the deformation inducing unit may be smaller than a width of a body unit arranged opposite from the connecting unit of the conductive plate. Each connecting unit may be surrounded and sealed by the sealing member while each deformation inducing unit may be arranged adjacent and external to the sealing member. The sealing member may include a lower film arranged at bottom surfaces of the pair of the conductive plates, an upper film arranged at top surfaces of the pair of the conductive plates; and a flux arranged on the thermal fuse to prevent corrosion of the thermal fuse, the flux and the thermal fuse being arranged in between the upper and lower films.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic exploded perspective view of a secondary battery according to an embodiment of the present invention;

FIG. 2 is a partial cross-sectional view of the secondary battery of FIG. 1;

FIG. 3 is a schematic cross-sectional view of a current interrupting device according to a first embodiment of the present invention;

FIG. 4 is an exploded perspective view of first and second conductive plates, a lower film, and a thermal fuse of the current interrupting device shown in FIG. 3;

FIG. 5 is a plan view of the first and second conductive plates and a lower film of the current interrupting device shown in FIG. 3;

FIG. 6 is a schematic cross-sectional view of a current interrupting device according to a second embodiment of the present invention;

FIG. 7 is an exploded perspective view of first and second conductive plates and a thermal fuse of the current interrupting device shown in FIG. 6;

FIG. 8 is a plan view of the first and second conductive plates and a lower film of the current interrupting device shown in FIG. 6; and

FIG. 9 is an exploded perspective view of first and second conductive plates and a thermal fuse of a current interrupting device according to a third embodiment of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that although the terms first and second are used herein to describe various elements, these elements should not be limited by these terms. These terms are only used to distinguish one element from another element.

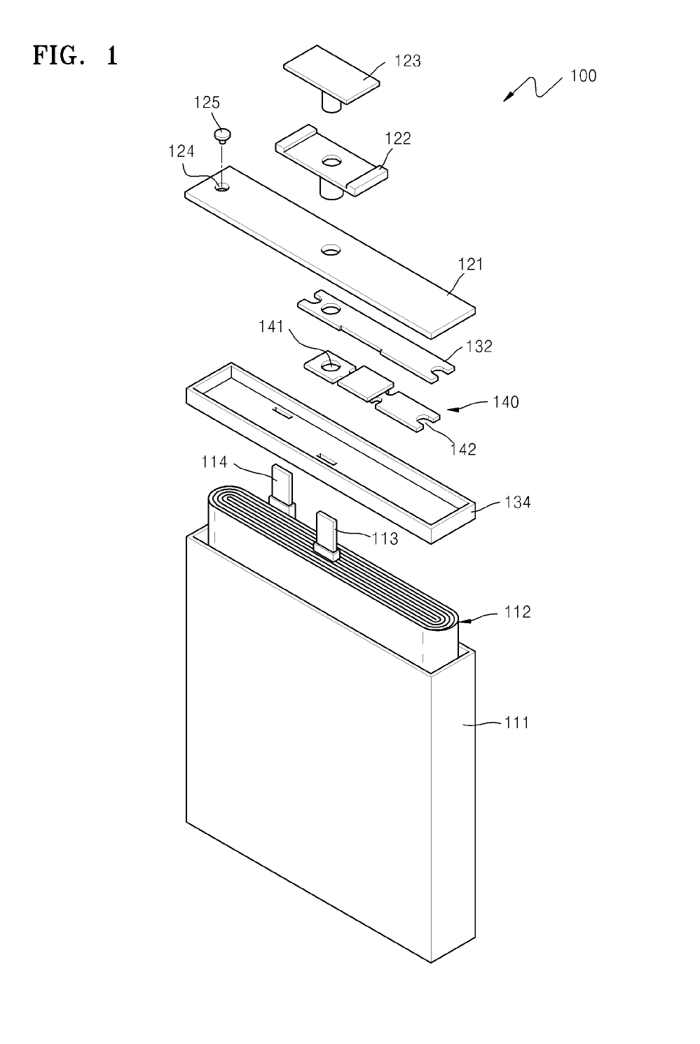

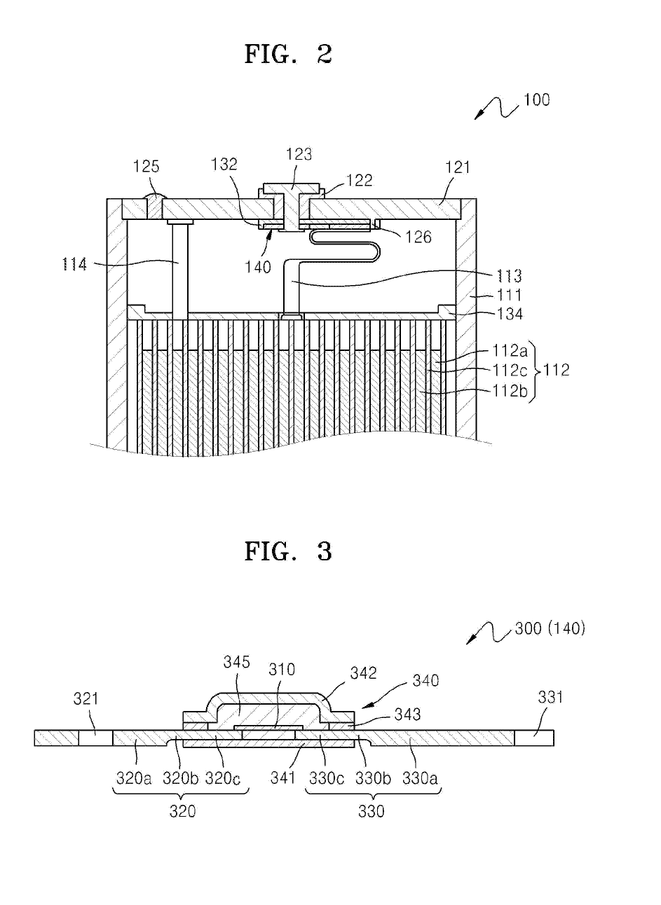

Turning now to FIGS. 1 and 2, FIG. 1 is a schematic exploded perspective view of a secondary battery 100 according to an embodiment of the present invention, and FIG. 2 is a partial cross-sectional view of the secondary battery 100. Referring to FIGS. 1 and 2, the secondary battery 100 includes an electrode assembly 112, a can 111 in which the electrode assembly 112 is accommodated, a cap plate 121 for sealing an opening of the can 111, and a current interrupting device 140 arranged inside the can 111.

The electrode assembly 112 may include a negative electrode plate 112a and a positive electrode plate 112b, to which electrode active materials are applied, and a separator 112c interposed therebetween. The electrode assembly 112 may be formed by forming a stacked structure in which the negative electrode plate 112a, the separator 112c, and the positive electrode plate 112b are stacked in the order stated and winding the stacked structure to produce a jelly-roll configuration. The negative electrode plate 112a and the positive electrode plate 112b may be electrically connected to first and second electrode tabs 113 and 114, which are arranged for transferring charges formed in chemical reactions to outside, respectively.

The electrode assembly 112 may be accommodated inside the can 111 while being impregnated with an electrolyte (not shown). The opening of the can 111 may be sealed by the cap plate 121 after the electrode assembly 112 is accommodated inside the can 111. The cap plate 121 and the can 111 may be laser-welded to maintain the internal space airtight.

An electrolyte inlet 124 may be formed at the cap plate 121. After the cap plate 121 and the can 111 are combined, the electrolyte is injected via the electrolyte inlet 124, and the electrolyte inlet 124 may be sealed by a cap 125.

An electrode terminal 123 may be arranged on the cap plate 121. A first end of the electrode terminal 123 is exposed to an outside via a top surface of the cap plate 121, whereas a second end of the electrode terminal 123 penetrates through the cap plate 121 into the can 111.

The cap plate 121 and the can 111 may include electrically conductive materials. The electrode terminal 123 may be electrically connected to the first electrode tab 113 of the electrode assembly 112 and may have a first polarity, whereas the cap plate 121 may be electrically connected to the second electrode tab 114 of the electrode assembly 112 and may have a second polarity.

For example, the cap plate 121 may function as a positive electrode of the secondary battery 100, whereas the electrode terminal 123 may function as a negative electrode of the secondary battery 100. Here, a gasket 122 including an insulating material may be arranged between the cap plate 121 and the electrode terminal 123 to prevent short-circuits therebetween.

Inside the can 111, an insulating case 134 may be arranged above the electrode assembly 112. The insulating case 134 may insulate the electrode assembly 112 from the cap plate 121. The insulating case 134 may include via holes through which the first and second electrode tabs 113 and 114 may be withdrawn.

The current interrupting device 140 is arranged inside the can 111 and is fused when the surrounding temperature exceeds a reference temperature. By using the current interrupting device 140, ignition or explosion of the secondary battery 100 due to overcurrent may be prevented.

The current interrupting device 140 is arranged inside the can 111 and may be electrically connected to the electrode terminal 123 and the first electrode tab 113. The current interrupting device 140 may be arranged below the cap plate 121.

A hole 141 that may be formed at a first end of the current interrupting device 140 such that the second end of the electrode terminal 123 may penetrate the hole 141, whereas a groove 142 is formed at a second end of the current interrupting device 140 to be combined with a protrusion 126 formed on a bottom surface of the cap plate 121.

As the second end of the electrode terminal 123 penetrates the hole 141 formed at the first end of the current interrupting device 140, a position of the current interrupting device 140 may be fixed. At the same time, the current interrupting device 140 may be electrically connected to the electrode terminal 123. An insulator 132 may be arranged between the cap plate 121 and the current interrupting device 140 to prevent a short-circuit between the current interrupting device 140 and the cap plate 121.

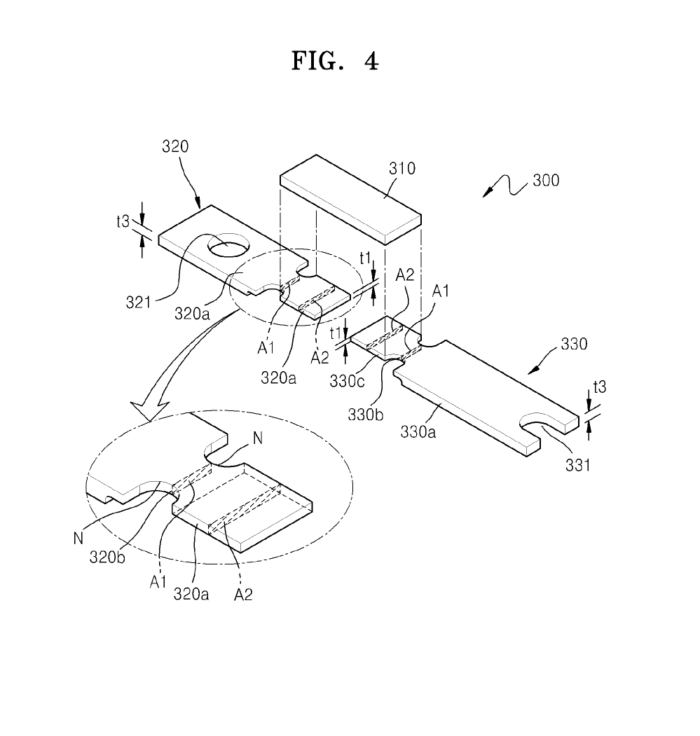

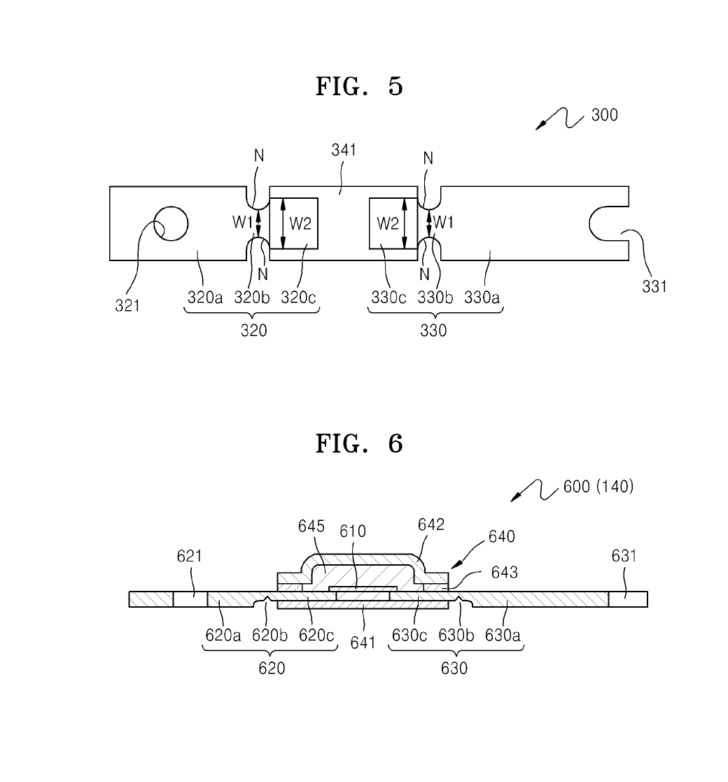

Turning now to FIGS. 3-5, FIG. 3 is a schematic cross-sectional view of a current interrupting device 300 according to a first embodiment of the present invention, FIG. 4 is an exploded perspective view of first and second conductive plates, a lower film, and a thermal fuse of the current interrupting device 300 shown in FIG. 3, and FIG. 5 is a plan view of the first and second conductive plates and a lower film of the current interrupting device 300 shown in FIG. 3. For convenience of explanation, a sealing member is omitted from FIG. 4, and only the first and second conductive plates and the lower film are shown in FIG. 5.

Referring now to FIG. 3, the current interrupting device 300 according to the present embodiment may include a thermal fuse 310, first and second conductive plates 320 and 330, and a sealing member 340. The thermal fuse 310 is arranged on the first and second conductive plates 320 and 330, which are a predetermined distance apart from each other, and the thermal fuse 310 may be surrounded by the sealing member 340.

The thermal fuse 310 may include a conductive material via which current flows. For example, the thermal fuse 310 may include tin (Sn), bismuth (Bi), indium (In), lead (Pb), zinc (Zn), or an alloy thereof.

The thermal fuse 310 may block current according to a temperature of surroundings of the current interrupting device 300. For example, if the surrounding temperature exceeds a reference temperature, the thermal fuse 310 may block the current by being blown. A first end of the thermal fuse 310 may be connected to the first conductive plate 320, whereas a second end of the thermal fuse 310 may be connected to the second conductive plate 330.

The first conductive plate 320 and the second conductive plate 330 may include a metal. For example, the first and second conductive plates 320 and 330 may include nickel, copper, iron, or an alloy thereof such as invar, which is an alloy of nickel and iron.

The sealing member 340 may seal the thermal fuse 310 and the first and second connecting units 320c and 330c of the first and second conductive plates 320 and 330 that are combined with the thermal fuse 310. As described above with reference to FIGS. 1 and 2, since the current interrupting device 140 is arranged inside the secondary battery 100, the current interrupting device 140 may be directly exposed to the electrolyte. Since the secondary battery 100 is used for an extended period of time and is repeatedly charged and discharged, the current interrupting device 140, and more particularly, the thermal fuse 310, may be corroded by the electrolyte. Once the thermal fuse 310 is corroded, it may be difficult for the thermal fuse 310 to function normally, that is, to block current at a temperature exceeding the reference temperature. Therefore, the thermal fuse 310 may be prevented from being corroded by appropriately including and arranging the sealing member 340 which seals the thermal fuse 310 and the connection between the thermal fuse 310 and the first and second conductive plates 320 and 330.

The sealing member 340 may include a lower film 341 and an upper film 342. The lower film 341 is attached to the bottom of the first and second conductive plates 320 and 330, and more particularly, bottom surfaces of the first and second connecting units 320c and 330c. The upper film 342 is attached to top surfaces of the first and second conductive plates 320 and 330, and more particularly, top surfaces of the first and second connecting units 320c and 330c.

The lower film 341 and the upper film 342 may include resin materials. For example, the lower film 341 and the upper film 342 may each include at least one of polyethylene naphthalate, polyethylene terephthalate, polyamide, polyimide, polybutyleneterephthalate, polyphenyleneoxide, polyethylene sulfide, and polysulfone. When the upper film 342 is attached to the top surfaces of the first and second connecting units 320c and 330c, an intermediate film 343 may be interposed therebetween.

The sealing member 340 may be filled with flux 345. The flux 345 is a polymer-based material and helps melting and breaking of the thermal fuse 310 by improving wettability. The flux 345 may also prevent corrosion of the thermal fuse 310.

The first conductive plate 320 may include a first body unit 320a, the first connecting unit 320c connected to a first end of the thermal fuse 310, and a first deformation inducing unit 320b interposed between the first body unit 320a and the first connecting unit 320c. The first body unit 320a may include a hole 321 which may be penetrated by an end of an electrode terminal 123, to connect the first body unit 320a to the first electrode tab 113.

While the first connecting unit 320c is sealed by the sealing member 340, the first deformation inducing unit 320b is not sealed by the sealing member 340 and is exposed to the outside, so that the first deformation inducing unit 320b is external to the sealing member 340.

The second conductive plate 330 may include a second body unit 330a, the second connecting unit 330c connected to a second end of the thermal fuse 310, and a second deformation inducing unit 330b interposed between the second body unit 330a and the second connecting unit 330c. The second body unit 330a may include a groove 331 with which a protrusion 126 arranged at the bottom of a cap plate 121 may be combined.

While the second connecting unit 330c is sealed by the sealing member 340, the second deformation inducing unit 330b is not sealed by the sealing member 340 and is exposed to the outside, so that the second deformation inducing unit 330b is arranged outside the sealing member 340.

Referring now to FIG. 4, the first connecting unit 320c is arranged at an end of the first conductive plate 320 and is connected to the thermal fuse 310. For example, the first connecting unit 320c may be welded to the thermal fuse 310. Here, a thickness t1 of the first connecting unit 320c may be smaller than a thickness t3 of the first body unit 320a to improve a combining strength between the first connecting unit 320c and the thermal fuse 310. In the current interrupting device 300 according to the first embodiment of the present invention, a thickness of the first deformation inducing unit 320b may be the same as the thickness t1 of the first connecting unit 320c. For example, the thickness of the first deformation inducing unit 320b and the thickness t1 of the first connecting unit 320c may be about 0.23 mm, whereas the thickness t3 of the first body unit 320a may be about 0.3 mm.

Similarly, the second connecting unit 330c is arranged at an end of the second conductive plate 330 and is connected to the thermal fuse 310. For example, the second connecting unit 330c may be welded to the thermal fuse 310. Here, a thickness t1 of the second connecting unit 330c may be smaller than a thickness t3 of the second body unit 330a to improve a combining strength between the second connecting unit 330c and the thermal fuse 310. In the current interrupting device 300 according to the first embodiment of the present invention, a thickness of the second deformation inducing unit 330b may be the same as the thickness t1 of the second connecting unit 330c. For example, the thickness of the second deformation inducing unit 330b and the thickness t1 of the second connecting unit 330c may be about 0.23 mm, whereas the thickness t3 of the second body unit 330a may be about 0.3 mm.

The cross-sectional area A1 of the first deformation inducing unit 320b may be smaller than the cross-sectional area A2 of the first connecting unit 320c. For example, the cross-sectional area A1 of the first deformation inducing unit 320b may be from about 30% to about 50% of the cross-sectional area A2 of the first connecting unit 320c. Meanwhile, the cross-sectional areas A1 and A2 of the first deformation inducing unit 320b and the first connecting unit 320c may be smaller than the cross-sectional area of the first body unit 320a.

If the cross-sectional area A1 of the first deformation inducing unit 320b is less than 30% of the cross-sectional area A2 of the first connecting unit 320c, a resistance with respect to a current flowing through the current interrupting device 300 increases, and thus it is difficult for the thermal fuse 310 to function properly and durability of the first deformation inducing unit 320b may be reduced. If the cross-sectional area A1 of the first deformation inducing unit 320b is more than 50% of the cross-sectional area A2 of the first connecting unit 320c, the first deformation inducing unit 320b may be insufficiently deformed by an external force.

In the same regard, the cross-sectional area A1 of the second deformation inducing unit 330b may be smaller than the cross-sectional area A2 of the second connecting unit 330c. For example, the cross-sectional area A1 of the second deformation inducing unit 330b may be from about 30% to about 50% of the cross-sectional area A2 of the second connecting unit 330c. Meanwhile, the cross-sectional areas A1 and A2 of the second deformation inducing unit 330b and the second connecting unit 330c may be smaller than the cross-sectional area of the second body unit 330a.

If the cross-sectional area A1 of the second deformation inducing unit 330b is less than 30% of the cross-sectional area A2 of the second connecting unit 330c, resistance with respect to a current flowing through the current interrupting device 300 increases, and thus it is difficult for the thermal fuse 310 to function properly and durability of the second deformation inducing unit 330b may be reduced. If the cross-sectional area A1 of the second deformation inducing unit 330b is more than 50% of the cross-sectional area A2 of the second connecting unit 330c, the second deformation inducing unit 330b may be insufficiently deformed by an external force.

Referring now to FIG. 5, the first deformation inducing unit 320b may include a notch N that is formed in a widthwise direction of the current interrupting device 300. Due to the notch N formed in the first deformation inducing unit 320b, the width w1 of the first deformation inducing unit 320b may be smaller than the width w2 of the first connecting unit 320c. Meanwhile, the widths w1 and w2 of the first deformation inducing unit 320b and the first connecting unit 320c may be smaller than the width of the first body unit 320a. For example, the width w1 of the first deformation inducing unit 320b may be about 0.9 mm, the width w2 of the first connecting unit 320c may be about 1.4 mm, and the width of the first body unit 320a may be about 2.3 mm.

The second deformation inducing unit 330b may include a notch N that is formed in the widthwise direction of the current interrupting device 300. Due to the notch N formed in the second deformation inducing unit 330b, the width w1 of the second deformation inducing unit 330b may be smaller than the width w2 of the second connecting unit 330c. Meanwhile, the widths w1 and w2 of the second deformation inducing unit 330b and the second connecting unit 330c may be smaller than the width of the second body unit 330a. For example, the width w1 of the second deformation inducing unit 330b may be about 0.9 mm, the width w2 of the second connecting unit 330c may be about 1.4 mm, and the width of the second body unit 330a may be about 2.3 mm.

The notches N formed in the first deformation inducing unit 320b and the second deformation inducing unit 330b may be rounded grooves for uniform weight distribution. For example, the notches N may be U-shaped grooves with about 0.35 mm curvatures.

Due to the first deformation inducing unit 320b and the second deformation inducing unit 330b as described above, when an external force are applied to the first conductive plate 320 and the second conductive plate 330, the first and second conductive plates 320 and 330 may be elastically bent-deformed around the first deformation inducing unit 320b and the second deformation inducing unit 330b, respectively.

For example, if an external force (e.g., a weight) is applied to the first conductive plate 320 and/or the second conductive plate 330, the first conductive plate 320 and/or the second conductive plate 330 are/is bent around the first deformation inducing unit 320b and/or the second deformation inducing unit 330b, respectively. When the external force is removed, the first conductive plate 320 and/or second conductive plate 330 are/is restored to their original shape(s). During fabrication or assembly of the current interrupting device 300, even if an external force is applied to the current interrupting device 300, the first deformation inducing unit 320b and/or the second deformation inducing unit 330b are/is deformed, and thus force applied to the first connecting unit 320c and/or the second deformation inducing unit 330c are/is reduced. As a result, sealing between the sealing member 340 and the first connecting unit 320c and/or the second connecting unit 330c may be maintained.

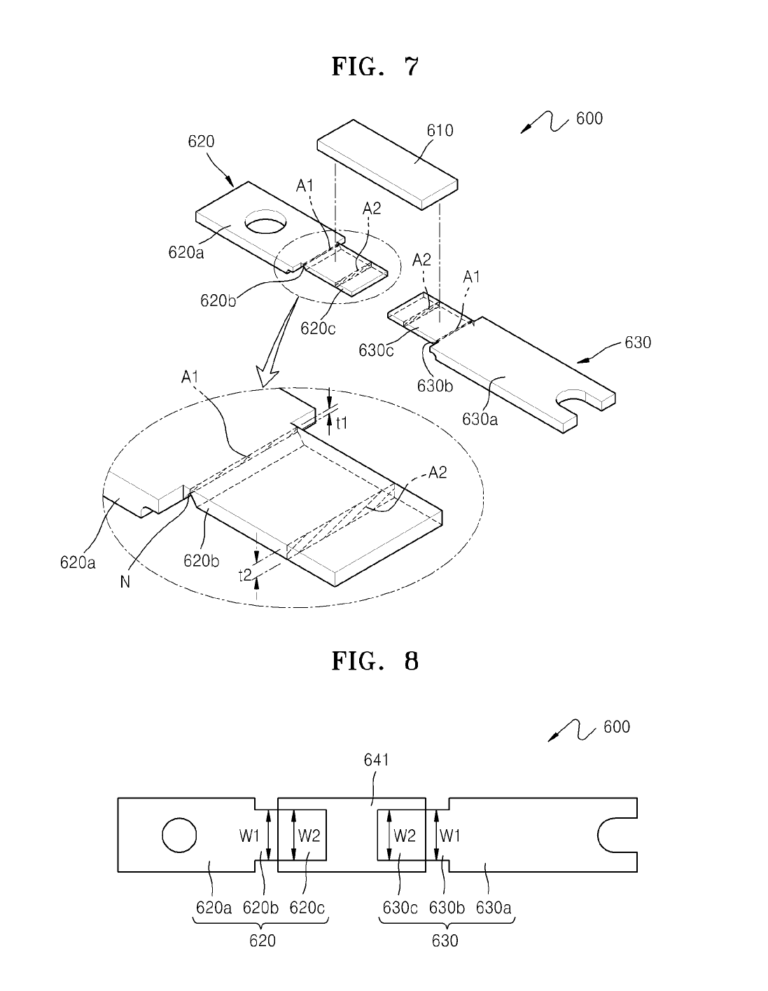

Turning now to FIGS. 6-8, FIG. 6 is a schematic cross-sectional view of a current interrupting device 600 according to a second embodiment of the present invention, FIG. 7 is an exploded perspective view of first and second conductive plates and a thermal fuse of the current interrupting device 600 shown in FIG. 6, and FIG. 8 is a plan view of the first and second conductive plates and a lower film of the current interrupting device 600 shown in FIG. 6. For convenience of explanation, a sealing member is omitted from FIG. 7, and only the first and second conductive plates and a lower film are shown in FIG. 8.

Referring now to FIG. 6, the current interrupting device 600 according to the second embodiment may include a thermal fuse 610, first and second conductive plates 620 and 630, and a sealing member 640. The thermal fuse 610 is arranged on the first and second conductive plates 620 and 630 that are a predetermined distance apart from each other, and the thermal fuse 610 may be surrounded by the sealing member 640. The sealing member 640 may include upper and lower films 641 and 642 and an intermediate film 643 and may be filled with a flux 645. The detailed configurations of the thermal fuse 610, the first and second conductive plates 620 and 630, and the sealing member 640 constituting the current interrupting device 600 according to the second embodiment are the same as those of the equivalent components described above.

However, although the notches N are formed in the first and second deformation inducing units 320b and 330b of the current interrupting device 300 described previously in the first embodiment with reference to FIGS. 3 through 5 in the widthwise direction, notches N are formed in the first and second deformation inducing units 620b and 630b of the current interrupting device 600 according to the second embodiment in the thickness-wise direction. Detailed descriptions of components that are the same as those described above in relation to the current interrupting device 300 will be omitted, and the descriptions given below will focus on differences between the current interrupting device 600 of the second embodiment as compared to the current interrupting device 300 of the first embodiment.

Referring now to FIG. 7, the cross-sectional area A1 of the first deformation inducing unit 620b may be smaller than the cross-sectional area A2 of the first connecting unit 620c, whereas the cross-sectional area A1 of the second deformation inducing unit 630b may be smaller than the cross-sectional area A2 of the second connecting unit 630c. For example, the cross-sectional areas A1 of the first and second deformation inducing units 620b and 630b may be from about 30% to about 50% of the cross-sectional area A2 of the first and second connecting units 620c and 630c, respectively. Meanwhile, the cross-sectional areas A1 and A2 of the first and second deformation inducing units 620b and 630b and the first and second connecting units 620c and 630c may be smaller than the cross-sectional areas of the first and second body units 620a and 630a, respectively.

If the cross-sectional areas A1 of the first and second deformation inducing units 620b and 630b are less than 30% of the cross-sectional areas A2 of the first and second connecting units 620c and 630c, respectively, resistance with respect to a current flowing through the current interrupting device 600 increases, and thus resistances of the first and second deformation inducing units 620b and 630b increase. Therefore, when a current flows through the first and second deformation inducing units 620b and 630b, the first and second deformation inducing units 620b and 630b are overheated, so that the thermal fuse 610 is blown at too low a temperature, and thus it is difficult for the thermal fuse 610 to function properly by blocking current only when an excessive temperature leading to an unsafe condition is present. Furthermore, by having the cross-sectional area A1 of the deformation inducing units 620b and 630b too small, durability of the first and second deformation inducing units 620b and 630b may be reduced.

On the other hand, if the cross-sectional areas A1 of the first and second deformation inducing units 620b and 630b exceed 50% of the cross-sectional areas A2 of the first and second connecting units 620c and 630c, respectively, the first and second deformation inducing units 620b and 630b may be insufficiently deformed. Therefore, when an external force is applied, an electrolyte may be introduced through a gap formed between the sealing member 640 and the first and second connecting units 620c and 630c, and thus the thermal fuse 610 may corrode.

Referring now to FIGS. 6 and 7, the first and second deformation inducing units 620b and 630b may include notches N formed in a thickness-wise direction of the current interrupting device 600. The notches N may be rounded grooves for uniform weight distribution.

Due to the notches N, the thickness t1 of the first and second deformation inducing units 620b and 630b may be smaller than the thickness t2 of the first and second connecting units 620c and 630c, respectively. Meanwhile, the thicknesses t1 and t2 of the first and second deformation inducing units 620b and 630b and the first and second connecting units 620c and 630c may be smaller than the thickness t3 of the first and second body units 620a and 630a, respectively. For example, the thickness t1 of the first and second deformation inducing units 620b and 630b may be about 0.16 mm, the thickness t2 of the first and second connecting units 620c and 630c may be about 0.23 mm, and the thickness t3 of the first and second body units 620a and 630a may be about 0.3 mm.

Referring now to FIG. 8, the width w1 of the first and second deformation inducing units 620b and 630b may be the same as the width w2 of the first and second connecting units 620c and 630c and may be smaller than the width w3 of the first and second body units 620a and 630a, respectively. For example, the widths w1 and w2 of the first and second deformation inducing units 620b and 630b and the first and second connecting units 620c and 630c may be 1.4 mm, whereas the width w3 of the first and second body units 620a and 630a may be about 2.3 mm.

Due to the structure described above, when an external force is applied to the current interrupting device 600, the first and second conductive plates 620 and 630 may be elastically bent-deformed around the first and second deformation inducing units 620b and 630b that are interposed between the first and second body units 620a and 630a and the first and second connecting units 620c and 630c, respectively.

For example, when an external force (e.g., a weight) is applied to the first conductive plate 620 and/or the second conductive plate 630, the first conductive plate 620 and/or the second conductive plate 630 is/are bent around the first deformation inducing unit 620b and/or the second deformation inducing unit 630b, and, when the external force is removed, the first conductive plate 620 and/or the second conductive plate 630 is/are restored to its/their original shape(s). Therefore, even if an external force is applied, sealing between the sealing member 640 and the first and second connecting units 620c and 630c is not destroyed, and thus corrosion of the thermal fuse 610 due to the introduction of an electrolyte may be prevented.

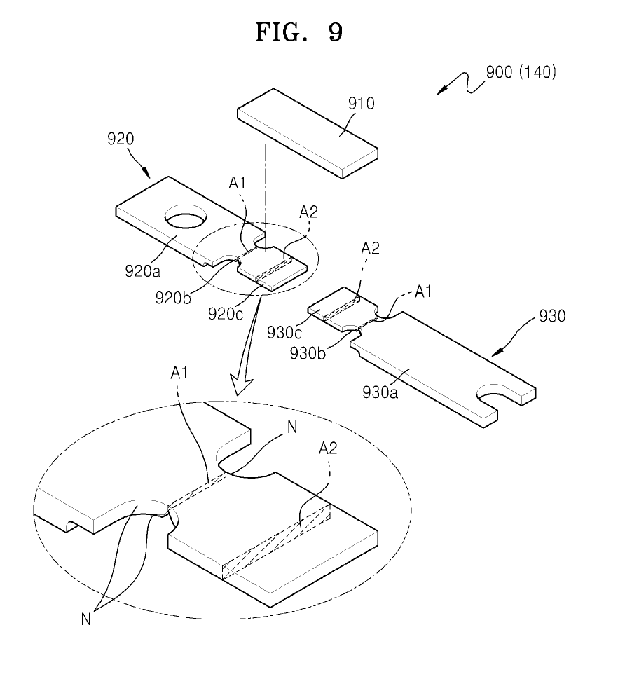

Turning now to FIG. 9, FIG. 9 is an exploded perspective view of first and second conductive plates and a thermal fuse of a current interrupting device 900 according to a third embodiment of the present invention. For convenience of explanation, a sealing member is omitted from FIG. 9.

The current interrupting device 900 according to the third embodiment may include a thermal fuse 910, first and second conductive plates 920 and 930, and a sealing member (not shown). The thermal fuse 910 is arranged on the first and second conductive plates 920 and 930 that are a predetermined distance apart from each other, and the thermal fuse 910 may be surrounded by the sealing member. The detailed configurations of the thermal fuse 910, the first and second conductive plates 920 and 930, and the sealing member constituting the current interrupting device 900 according to the third embodiment are the same as those of the equivalent components described above,

However, although the notches N are formed in the first and second deformation inducing units 320b, 330b, 620b, and 630b of the current interrupting devices 300 and 600 of the first and second embodiments as described above, in either the widthwise direction or in the thickness-wise direction, notches N are formed in the first and second deformation inducing units 920b and 930b of the current interrupting device 900 according to the third embodiment in both the widthwise direction and the thickness-wise direction.

Referring now to FIG. 9, the cross-sectional area A1 of the first deformation inducing unit 920b may be smaller than the cross-sectional area A2 of the first connecting unit 920c, whereas the cross-sectional area A1 of the second deformation inducing unit 930b may be smaller than the cross-sectional area A2 of the second connecting unit 930c. For example, the cross-sectional area A1 of the first and second deformation inducing units 920b and 930b may be from about 30% to about 50% of the cross-sectional area A2 of the first and second connecting units 920c and 930c. Meanwhile, the cross-sectional areas A1 and A2 of the first and second deformation inducing units 920b and 930b and the first and second connecting units 920c and 930c may be smaller than the cross-sectional areas of the first and second body units 920a and 930a, respectively.

If the cross-sectional area A1 of the first and second deformation inducing units 920b and 930b is less than 30% of the cross-sectional area A2 of the first and second connecting units 920c and 930c, when currents flow through the first and second deformation inducing units 920b and 930b, the first and second deformation inducing units 920b and 930b overheat, so that the thermal fuse 910 is blown at too low a temperature, and thus it is difficult for the thermal fuse 910 to function properly by blocking a current only when the temperature rises too high to unsafe levels. Furthermore, durability of the first and second deformation inducing units 920b and 930b may be reduced. On the other hand, if the cross-sectional areas A1 of the first and second deformation inducing units 920b and 930b exceed 50% of the cross-sectional areas A2 of the first and second connecting units 920c and 930c, respectively, the first and second deformation inducing units 920b and 930b may be insufficiently deformed. Therefore, when an external force is applied, an electrolyte may be introduced through a gap formed between the sealing member 940 and the first and second connecting units 920c and 930c, and thus the thermal fuse 910 may corrode.

The first and second deformation inducing units 920b and 930b may include notches N that are formed in the widthwise direction and in the thickness-wise direction of the current interrupting device 900. The notches N may be rounded grooves for uniform weight distribution.

Due to the notches N formed in the widthwise direction, the width of the first and second deformation inducing units 920b and 930b may be smaller than the width of the first and second connecting units 920c and 930c. Furthermore, the widths of the first and second deformation inducing units 920b and 930b and the first and second connecting units 920c and 930c may be smaller than the width of the first and second body units 920a and 930a.

Due to the notches N formed in the thickness-wise direction, the thickness of the first and second deformation inducing units 920b and 930b may be smaller than the thickness of the first and second connecting units 920c and 930c. Furthermore, the thicknesses of the first and second deformation inducing units 920b and 930b and the first and second connecting units 920c and 930c may be smaller than the thickness of the first and second body units 920a and 930a.

Due to the structure as described above, when an external force is applied to the current interrupting device 900, the first and second conductive plates 920 and 930 may be elastically bent-deformed around the first and second deformation inducing units 920b and 930b, respectively. Therefore, sealing of the sealing member may be maintained.

As described above, according to the one or more of the above embodiments of the present invention, current interrupting devices having deformation inducing units which include notches in the widthwise direction and/or the thickness-wise direction and have cross-sectional area smaller than that of connecting units, are provided. Consequently, upon an application of an external force, the deformation inducing units allow the current interruption device to flex, thereby preserving the integrity of a seal between a sealing member and a thermal fuse, so that the thermal fuse will not be exposed to the electrolyte and corrode. Therefore, even if an external force is applied to the current interrupting device, sealing of a sealing member may be maintained, and thus a thermal fuse may be prevented from being corroded by an electrolyte. Therefore, safety of a secondary battery that is to be used for an extended period of time may be improved.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A current interrupting device, comprising:
a thermal fuse;
a pair of conductive plates respectively connected to two opposite ends of the thermal fuse; and
a sealing member that surrounds and seals the thermal fuse, wherein each of the conductive plates comprises a connecting unit that is connected to the thermal fuse, and wherein at least one of the pair of conductive plates comprises a deformation inducing unit that is arranged adjacent to the connecting unit and has a smaller cross-sectional area than a cross-sectional area of the connecting unit.

2. The current interrupting device of claim 1, wherein the cross-sectional area of the deformation inducing unit is from about 30% to about 50% of the cross-sectional area of the connecting unit.

3. The current interrupting device of claim 1, wherein the deformation inducing unit comprises a notch arranged in a widthwise direction of the current interrupting device.

4. The current interrupting device of claim 1, wherein the deformation inducing unit comprises a notch arranged in a thickness-wise direction of the current interrupting device.

5. The current interrupting device of claim 1, wherein a thickness of the connecting unit and a thickness of the deformation inducing unit are smaller than a thickness of a body unit arranged opposite from the connecting unit of the conductive plate.

6. The current interrupting device of claim 1, wherein the connecting units are surrounded and sealed by the sealing member, and each of the at least one deformation inducing unit is external and adjacent to the sealing member.

7. A secondary battery, comprising:
an electrode assembly including a positive electrode plate, a separator, and a negative electrode plate;
a can including an opening and a space to accommodate both the electrode assembly and an electrolyte;
a cap plate to seal the opening of the can; and
a current interrupting device arranged inside the can, wherein the current interrupting device comprises:
a thermal fuse;
a pair of conductive plates that are respectively connected to two opposite ends of the thermal fuse; and
a sealing member that surrounds and seals the thermal fuse and the connections between the conductive plates and the thermal fuse, each of the conductive plates comprising:
a connecting unit that is connected to the thermal fuse; and
a deformation inducing unit arranged adjacent to the connecting unit, wherein a cross-sectional area of the deformation inducing unit is smaller than a cross-sectional area of the connecting unit.

8. The secondary battery of claim 7, wherein the cross-sectional area of the deformation inducing unit is from about 30% to about 50% of the cross-sectional area of the connecting unit.

9. The secondary battery of claim 8, wherein the cross-sectional area of the connecting unit and the cross-sectional area of the deformation inducing unit are smaller than a cross-sectional area of a body unit arranged opposite from the connecting unit of the conductive plate.

10. The secondary battery of claim 7, wherein the deformation inducing unit comprises a notch arranged in a widthwise direction of the current interrupting device.

11. The secondary battery of claim 10, wherein the deformation inducing unit also comprises a notch arranged in a thickness-wise direction of the current interrupting device.

12. The secondary battery of claim 7, wherein the deformation inducing unit comprises a notch arranged in a thickness-wise direction of the current interrupting device.

13. The secondary battery of claim 7, wherein a width of the deformation inducing unit is smaller than a width of the connecting unit.

14. The secondary battery of claim 7, wherein a thickness of the deformation inducing unit is smaller than a thickness of the connecting unit.

15. The secondary battery of claim 7, further comprising:
an electrode terminal including a first end exposed to an outside via a top surface of the cap plate and a second end penetrating through the cap plate and being combined with the current interrupting device; and
an electrode tab extending from the electrode assembly to the current interrupting device.

16. The secondary battery of claim 15, wherein the pair of conductive plates comprises:
a first conductive plate perforated by an aperture, the electrode terminal extending through the aperture, and
a second conductive plate including a groove that combines with a bottom surface of the cap plate.

17. The secondary battery of claim 7, wherein a thickness of the connecting unit and a thickness of the deformation inducing unit are smaller than the thickness of a body unit arranged opposite from the connecting unit of the conductive plate.

18. The secondary battery of claim 7, wherein a width of the connecting unit and a width of the deformation inducing unit are smaller than a width of a body unit arranged opposite from the connecting unit of the conductive plate.

19. The secondary battery of claim 7, wherein each connecting unit is surrounded and sealed by the sealing member while each deformation inducing unit is arranged adjacent and external to the sealing member.

20. The secondary battery of claim 7, wherein the sealing member comprises:
a lower film arranged at bottom surfaces of the pair of the conductive plates;
an upper film arranged at top surfaces of the pair of the conductive plates; and
a flux arranged on the thermal fuse to prevent corrosion of the thermal fuse, the flux and the thermal fuse being arranged in between the upper and lower films.
